(19) United States
(12) Patent Application Publication
(10) Pub. No.: US 2004/0039842 A1
(43) Pub. Date: Feb. 26, 2004

(54) Method for searching internet domain names

(76) Inventor: Paul Pilkington, Lorenzana (IT)

Correspondence Address: YOUNG & THOMPSON, 745 SOUTH 23RD STREET 2ND FLOOR, ARLINGTON, VA, 22202

(21) Appl. No.: 10/450,508

(22) PCT Filed: Dec. 15, 2000
(86) PCT No.: PCT/IT00/00525

(51) Int. Cl. G06F 15/16; G06F 17/30

(52) U.S. Cl. 709/245; 707/4

(57) ABSTRACT

A method that permits searches on the web, with the aim of creating web directories constituted by domain names that are the result of the transposition and permutation of the positions of the letters and numbers contained in the term used into its possible combinations of alphanumeric variations. Thanks to said method, to be carried out on a computer program, the utilization and locating of domain names obtained from the said transpositions, which until now have been unused due to their lack of meaning, is made possible. By inserting a given key word a list of domain names is obtained which correspond to its variants, as described above, so as said variants become useful domain names in order to be easily accessed in internet.

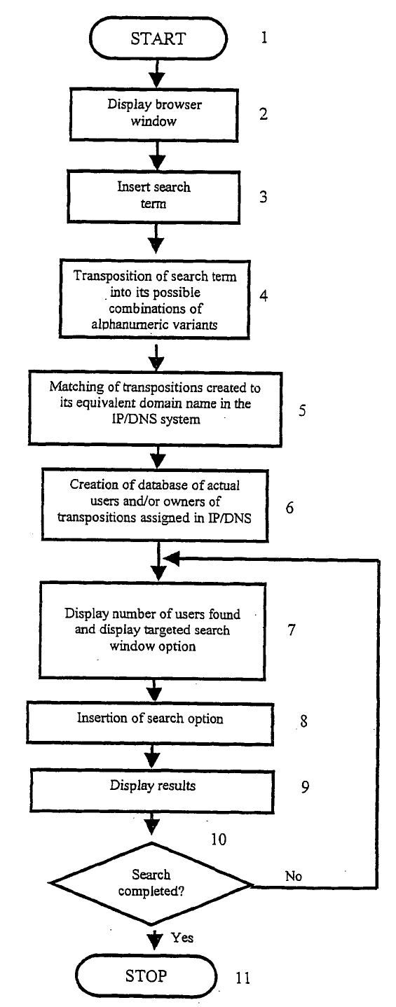

### TECHNICAL FIELD

The present invention relates to the technical sector of information technology and in particular deals with search and selection systems for internet domains or web pages.

### BACKGROUND ART

Different types of searches are well known which function by inserting one or more key words. The system selects a list of telematic addresses that satisfy the search parameters selected.

Currently, the said systems operate a search selecting the pages that contain in the title, in the text, or in the “meta-tag”, the words which are inserted in the search fields. The “meta-tag” is a string from the construction program of a web page in which site builders can insert words with which they can be located on the web.

Moreover, search systems are known, such as the one used by “Real Names”, which functions by matching a name or one or more keywords to a specific site so as to enable the user, after inserting a certain parameter into the search engine to be automatically sent to the selected client's site.

Known systems function through the insertion of data onto the internet constituted by the DNS, Domain Name System, that is the method by which every internet site is univocally traceable by a numerical code known as IP, corresponding to a single name, intended as an alphanumeric string of a determined length. The functioning of the DNS system constitutes Prior Art for a technician in this field.

The aforementioned systems have the significant handicap of supplying search results which aren't very precise, or which are too broad by selecting sites which bear little relation to the subject, or conversely that exclude certain sites that could be more useful. It is known by experts in this field that the future of internet is moving towards the “vertical organisation” of information, therefore a real need exists to have a greater amount of material related to a specific subject, rather than an overall panorama of everything that may be found on the net.

To satisfy these demands, so called “portals” are well-known, which according to the site manager's discretion, allow the user to navigate between sites with analogous subjects, or others that are displayed on the portal's pages.

Said systems are not satisfactory either, as the choice of whether one site or another is inserted depends principally on the portal manager's discretion. Furthermore, however wide-ranging these portals may be, they still only offer a limited view of the resources available on the internet relating to the search theme.

The aim of the present invention is to eliminate or reduce these and other disadvantages by providing a system that allows a series of pages which correspond to domain names resulting from a transposition of the keyword previously inserted in the search field to be located, also permitting the utilization of names that do not refer directly to a certain product, but which are of interest due to the fact that they are easy to memorize.

Among the names resulting from the search, it will then be easy to trace those which deal with the theme being investigated. These and other objectives are achieved by a system having the characteristics described in the independent claims. Other characteristics are subject to dependent claims. These and other advantages and characteristics of the present invention will be further and better understood by every technical expert in this field from the following description, aided by the enclosed drawing which illustrates the flow chart of the system in question.

### DISCLOSURE OF INVENTION

Reduced to its essential structure and with reference to the enclosed flow chart, a method for the creation of web directories in conformity with the invention is characterized by the following steps:

start up of system and display of the window where it will be possible to insert key word for the search;

insertion by user of an alphanumeric term that allows the search parameters to be determined;

automatic transposition of the inserted term through the permutation of the positions of the letters and numbers contained in the term into its possible combinations of alphanumeric variations without taking into account any meanings or such of the term thus obtained;

matching of every term thus obtained from said transposition to its equivalent domain name in the DNS system;

creation of a database containing the list of domain names found and which correspond to one or more terms obtained from the said transposition;

display of total or partial result.

Advantageously, following the result obtained using the steps described above, the method foresees the display of another search window in which it is possible to introduce a new keyword to delimit the display to a number of domains corresponding to the new parameter inserted, using steps 7-10 as described in the flow chart. The said step that delimits the search may be repeated as often as necessary until the theme being investigated has been targeted perfectly. Advantageously, the alphanumeric name to be inserted in the display window, using step 3 of the flow chart may be of any type, and by increasing the number of letters and/or numbers which it is made up of, it increases the possible number of combinations obtainable by the transposition of the term and the permutation of the position of the letters and/or numbers it is composed of.

For example, choosing to insert the word “wine” would give 24 possible combinations, among which the following “eniw, niwe, wein,” and so on, whereas inserting the word “television” would bring 3,628,800 possible combinations.

Advantageously, the transposition of the term generates a series of combinations that may all be valid to the search, as it is not necessary that the term obtained from the transposition and permutation has any real meaning.

Advantageously, with the said method, all those domains that result from a transposition of the term become significant thereby making available and useful domains, which though theoretically possible, until now have been unused due to their lack of meaning.

For example, a wine producer could be interested in registering the domain name “niwe.com”, or with another top level domain, so that the user who is adopting the proposed method, on typing “wine” in the browser window will obtain a list of sites among which will also be the one corresponding to the word “niwe” which is the transposition of the word “wine” originally entered.

Advantageously, in conformity with step 6 of the enclosed flow chart, the method allows the creation of a database which contains, among all possible domain names obtainable from the transposition of the inserted term, only those which result being effectively active so as to offer a list of pages that can actually be consulted.

Advantageously, in conformity with step 8 of the flow chart, in order to delimit the search any keyword can be inserted or alternatively a different selection method may be chosen that takes account, for example, of the most visited site; those with most pages; or that are written in one language as opposed to another and so forth.

Advantageously, the method is activated through a computer program, loaded directly onto the machine or peripheral device which will carry out all the said steps and one or more of the functions indicated.

Advantageously, the program can be installed and made visible within traditional search engines or constitute a new and separate search engine in itself.

The advantages that derive from the present invention consist essentially in that it makes available an elevated number of domains, which though theoretically possible, until now have been unused due to their lack of meaning; that it enables targeted searches by selecting only-those sites that deal with a well-defined subject and forming part of those constituted by one or more variants of the name inserted as a search parameter; that the commercial value and technical importance of domains with great appeal will be reduced as each one of them will be flanked by a range of possible combinations that guarantee the same visibility on the web as the original term has.

In practice, the particulars of execution may vary in an equivalent manner in form, dimension, disposition of the elements, nature of materials employed, while still remaining within the limits of the protection granted by the present patent for an industrial invention.

### BRIEF DESCRIPTION OF DRAWINGS

The enclosed drawing reproduces the flow chart of the method and of the program as described above.

1. Method for the creation of web directories in conformity with the invention characterized by the following steps:
start up of system and display of the window where it will be possible to insert key word for the search;
insertion by user of an alphanumeric term that allows the search parameters to be determined;
automatic transposition of the inserted term through the permutation of the positions of the letters and numbers contained in the term into its possible combinations of alphanumeric variations without taking into account any meanings or such of the term thus obtained;
matching of every term thus obtained from said transposition to its equivalent domain name in the DNS system;
creation of a database containing the list of domain names found and which correspond to one or more terms obtained from the said transposition;
display of total or partial result;

2. Method according to claim 1, characterized by the fact that following the result obtained using the steps described above, the method foresees the display of another search window in which it is possible to introduce a new keyword to delimit the display to a number of domains corresponding to the new parameter inserted, using steps 7-10 as described in the flow chart. The said step that delimits the search may be repeated as often as necessary until the theme being investigated has been targeted perfectly;

3. Method according to claim 1, characterized by the fact that the name to be inserted in the display window, using step 3 of the flow chart may be of any type, and by increasing the number of letters and/or numbers which it is made up of, it increases the possible number of combinations obtainable by the transposition of the term and the permutation of the position of the letters and/or numbers it is composed of;

4. Method according to claim 1, characterized by the fact that the transposition of the term generates a series of combinations that may all be valid to the search, as it is not necessary that the term obtained from the transposition and permutation has any real meaning;

5. Method according to claim 1, characterized by the fact that all those domains that result from a transposition of the term become significant thereby making available and useful domains, which though theoretically possible, until now have been unused due to their lack of meaning;

6. Method according to claim 1, characterized by the fact that in conformity with step 6 of the accompanying flow chart, the method allows the creation of a database which contains, among all possible domain names obtainable from the transposition of the inserted term, only those which result being effectively active so as to offer a list of pages that can actually be consulted;

7. Method according to claim 1, characterized by the fact that in conformity with step 8 of the flow chart, in order to delimit the search any keyword can be inserted or alternatively a different selection method may be chosen that takes account, for example, of the most visited site or those with most pages, or that are written in one language as opposed to another and so forth;

8. A computer program comprising computer code means adapted to perform all steps of the method according to claim 1, and one or more of the previous claims, when said program is run on a computer;

9. A computer program according to claim 8, embodied on a computer readable medium;

10. A computer program according to claims 8 and 9, characterized by the fact that it is installed on a computer and utilized as an independent search engine in itself, or alternatively may be inserted into traditional search engines.
